(19) United States
(12) Patent Application Publication
(10) Pub. No.: US 2002/0117609 A1
(43) Pub. Date: Aug. 29, 2002

(54) Angular position indicator for cranes

(76) Inventors: John Anthony Thibault, Edmonton (CA); Thomas Daniel Bilodeau, Edmonton (CA)

Correspondence Address: DAVIS & BUJOLD, P.L.L.C., 500 NORTH COMMERCIAL STREET, FOURTH FLOOR, MANCHESTER, NH, 03101, US

(21) Appl. No.: 09/796,039

(22) Filed: Feb. 28, 2001

(51) Int. Cl. G01D 5/34

(52) U.S. Cl. 250/231.14

(57) ABSTRACT

An angular position indicator for cranes which uses a combination of electronic, optical and mechanical components. It is intended for use on fixed or mobile Cranes and designed to operate in harsh industrial environments. Wireless communication replaces fixed electrical hardwiring that would otherwise be required between system components. The angular position indicator uses an angular displacement transducer of unique design. The angular position indicator performs pattern recognition of optical apertures using analog measurements of the illumination of optical detectors. The design allows for a substantial increase in measurement resolution as compared to digital optical encoders with the same number of optical channels.

### FIELD OF THE INVENTION

The present invention relates to an angular position indicator and, in particular, an angular position indicator suitable for use on a crane boom.

### BACKGROUND OF THE INVENTION

In order to calculate the lifting capacity of a crane several parameters must be measured, one of which is the angular position of the crane's boom.

### SUMMARY OF THE INVENTION

The present invention is a angular position indicator for a crane.

According to the present invention there is provided an angular position indicator for a crane boom which includes a base adapted for mounting to a crane boom that is to have its angular position measured. A pendulum is pivotally mounted to the base and hanging freely in a vertical orientation by force of gravity. An array of sensors for determining the angular positioning of the pendulum. A first set of processing electronics including a transmitter. A second set of processing electronics including a human readable display and a receiver. One of the first set of processing electronics and the second set of processing electronics calculates angular positioning of the crane boom from data received from the array of sensors. The second set of processing electronics is remote from the first set of processing electronics. The first set of processing electronics receives data from the array of sensors and transmits a signal which is received by the second set of processing electronics. The second set of processing electronics displays angular positioning of the crane boom on the human readable display.

The angular position indicator, as described above, is a wireless angular position indicator. This system provides numerous advantages over hardwired systems. Hardwired electrical cabling is difficult to install and is subject to physical damage and weathering which requires maintenance. Hardwired systems are difficult and, sometimes impossible, to install on cranes that have operator controls that do not move with the boom turret.

Although beneficial results may be obtained through the use of the angular position indicator, as described above, provision must be made to permit a number of cranes to operate in the same vicinity all of which are using a wireless system. Even more beneficial results may, therefore, be obtained when the signal passing from the first set of processing electronics to the second set of processing electronics has a unique identification code that preserves data integrity.

Although beneficial results may be obtained through the use of the angular position indicator, as described above, generally the higher the resolution obtained the more costly the angular position indicator. Even more beneficial results may be obtained when the array of sensors includes optical emitters and optical detectors fixed to the base and an optical encoder mounted to the pendulum. The optical emitters and optical detectors are angularly displaced in relation to the optical encoder mounted on the pendulum should any movement of the structure occur. The optical encoder has a series of optical apertures that generate unique identifiable light patterns detectable by the optical detectors. The unique identifiable light patterns including some optical apertures fully illuminated by the optical emitters, some optical apertures not illuminated by the optical emitters and at least one optical aperture partially illuminated by the optical emitters. The processing electronics assigns a fractional value to the degree of illumination of the optical aperture that is partially illuminated to enhance the resolution of the angular measurement. This approach enables higher resolution to be obtained using lower cost equipment with fewer optical channels.

Although beneficial results may be obtained through the use of the angular position indicator, as described above, oscillatory motion caused by vibration, shock and angular acceleration can adversely affect the accuracy and repeatability of the angular position measurement. Even more beneficial results may, therefore, be obtained when the mean angular displacement is displayed in order to compensate for oscillatory motion caused by vibration, shock and angular acceleration.

### BRIEF DESCRIPTION OF THE DRAWINGS

These and other features of the invention will become more apparent from the following description in which reference is made to the appended drawings, the drawings are for the purpose of illustration only and are not intended to in any way limit the scope of the invention to the particular embodiment or embodiments shown, wherein:

FIG. 1 is a block diagram of an angular position indicator constructed in accordance with the teachings of the present invention.

FIG. 2 is a block diagram of a display for the angular position indicator illustrated in FIG. 1.

FIG. 3 is a detailed side elevation view of the optical encoder disk and pendulum illustrated in FIG. 1.

### DETAILED DESCRIPTION OF THE PREFERRED EMBODIMENT

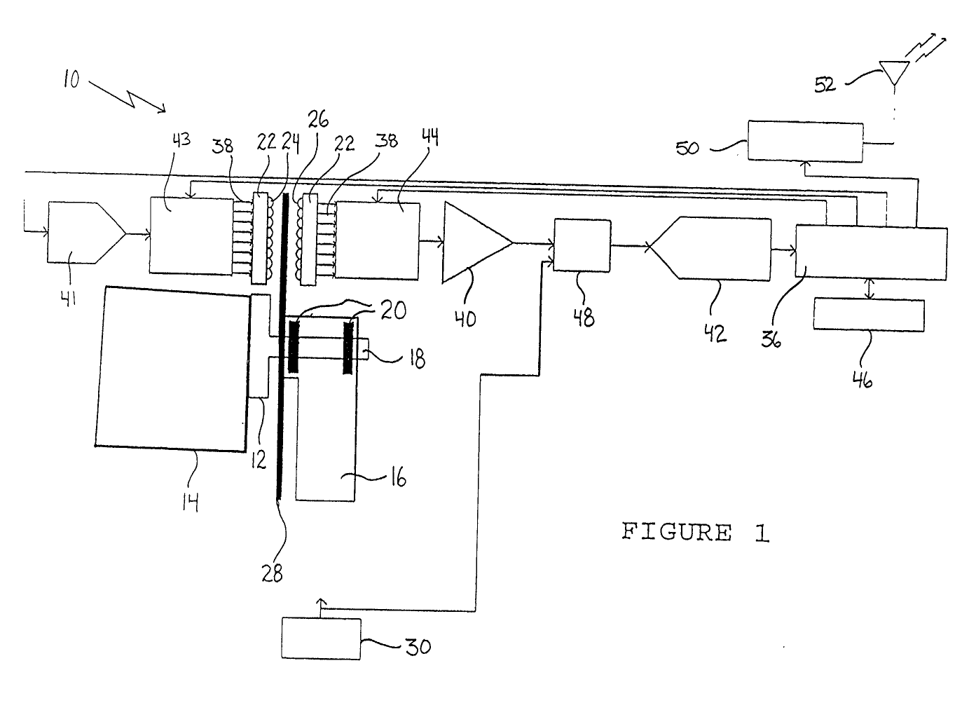

The preferred embodiment, an angular position indicator for a crane boom generally identified by reference numeral 10, will now be described with reference to FIGS. 1 through 3.

Structure and Relationship of Parts:

Referring to FIG. 1, there is provided an angular position indicator 10, that includes a base 12 mountable to a structure 14 that is to have its angular position measured. For example, angular position indicator 10 is often used to measure the angular position of a boom of a crane boom 14. A pendulum 16 is pivotally mounted to base 12 and hangs freely in a vertical orientation by force of gravity. Pendulum 16 is pivotally mounted by means of a shaft 18 journaled by bearings 20, thereby reducing dampening of the movement of pendulum 16 due to friction.

An array of sensors 22 is provided for determining the angular positioning of pendulum 16. Array of sensors 22 includes optical emitters 24 and optical detectors 26 fixed to base 12. An optical encoder 28 is mounted to pendulum 16, such that optical emitters 24 and optical detectors 26 are angularly displaced in relation to optical encoder 28 mounted on pendulum 16 should any movement of crane boom 14 occur. Angular position indicator 10 is supplied with power by a battery 30.

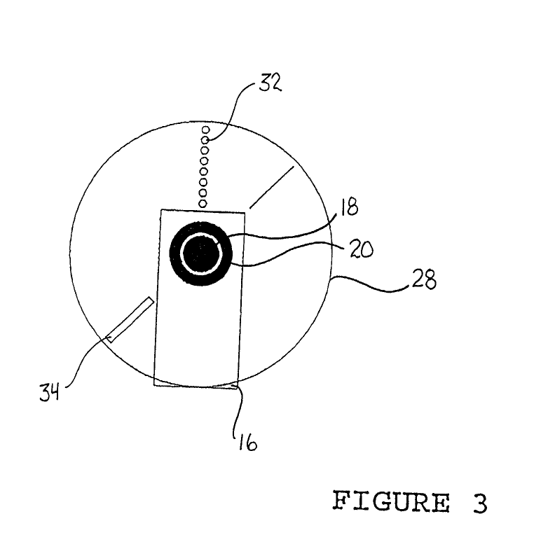

Referring to FIG. 3, optical encoder 28 has a series of optical apertures 32 that, when exposed to optical emitters 24, generate unique identifiable light patterns detectable by optical detectors 26. There are unique identifiable light patterns for every angular position, and specific illumination of the unique identifiable light patterns causes optical detectors 26 to generate a specific electrical current which is a function of angular displacement. Optical encoder 28 also includes a calibration aperture 34 that allows for full simultaneous illumination of optical detectors 26.

Referring to FIG. 1, a first microprocessor 36 is provided that receives data from array of sensors 22 and calculates an angular position. Optical detectors 26 and optical emitters 24 have several optical channels 38.

An analog signal amplifier 40 and an analog to digital converter 42 are provided. The electric current is passed from optical channels 38 through optical detector channel selectors 44 to analog signal amplifier 40 and through analog to digital converter 42 to convert the electric current to data in the form of binary code. First microprocessor 36 receives data from only one of optical channels 38 at a time. First microprocessor 36 includes an identification encoder 46 which supplies an identification code to be associated with data.

In the illustrated embodiment, an analog multiplexer 48 is interposed between analog signal amplifier 40 and analog to digital converter 42. Analog multiplexer 48 serves to route information concerning the condition of battery 30 to first microprocessor 36. First microprocessor 36 calculates mean angular displacement in order to compensate for oscillatory motion caused by vibration, shock and angular acceleration. First microprocessor 36 has a radio transmitter 50 with an antenna 52 for transmitting data along with the associated identification code, and information concerning the condition of battery 30.

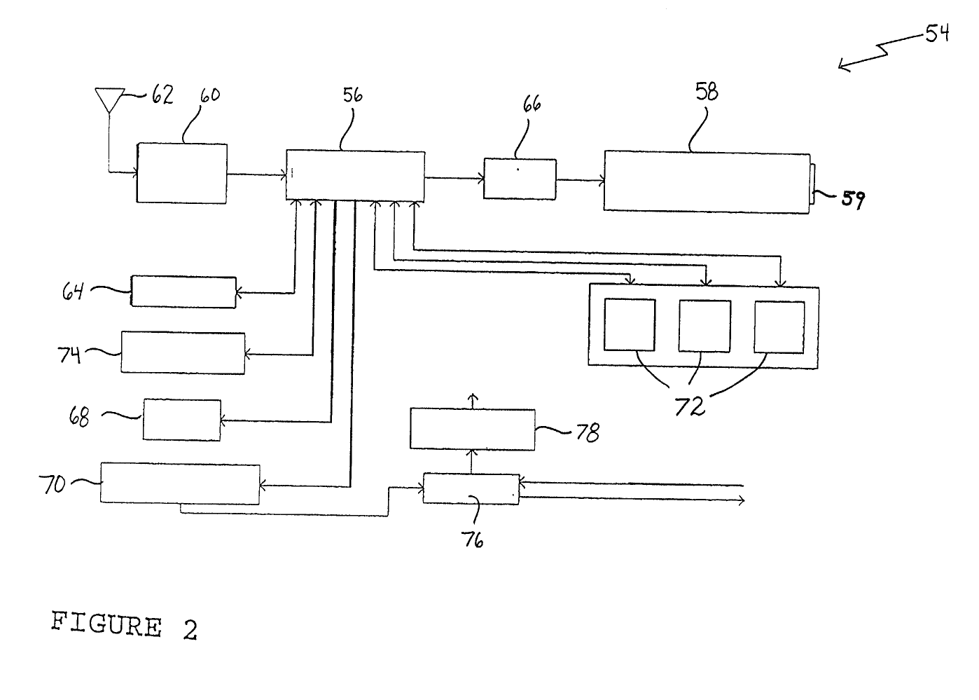

Referring to FIG. 2, there is provided a display unit generally referenced by numeral 54, that is separate from and operates at a distance from angular position indicator 10. Display unit 54 includes a second microprocessor 56 and a LCD display 58. Second microprocessor 56 has a radio receiver 60 with an antenna 62 for receiving data along with associated identification code, and information concerning condition of battery 30 from first microprocessor 36. Second microprocessor 56 has an identification encoder 64 which references the identification code associated with data received from first microprocessor 36. If the identification code is valid, LCD display 58 on display unit 54 displays the angular position in a readable format for viewing by an operator. It will be appreciated that displays other than LCD can be used, so long as display is readable by operator. A display driver 66 controls LCD display 58.

An auditory alarm 68 and a control voltage alarm 70 are connected to display unit 54. Auditory alarm 68 and control voltage alarm 70 are activated when angular position measured is outside of operator selected limits or when condition of battery 30 deteriorates. Operator selected limits are entered via input keys 72 on display unit 54 and are stored in non-volatile memory 74 such that second microprocessor 56 retains operator selected limits in the event supply of power to display unit 54 is interrupted. Power to display unit 54 is supplied externally through power connector 76 and regulated through power supply regulator 78.

Operation:

Operation: Mechanical.

The angle transducer consists of the following component groups:

shaft 18;

bearings 20

pendulum 16

optical encoder disk 28

digital to analog converter 41

optical emitter channel selector 43

8 element optical emitter 24

8 element optical detector 26

optical detector channel selector 44

analog signal amplifier 40

analog channel multiplexer 48

analog to digital converter 42

microprocessor 36 with ID encoder and battery pack

radio transmitter 50

i) The base 12 of ANGULAR POSITION INDICATOR 10 is mounted to a crane boom 14 that is to have its angular position measured. (eg. Crane Boom)

ii) The SHAFT 18 and BEARINGS 20 are mounted to the base 12.

iii) The OPTICAL ENCODER 28 is mounted to the PENDULUM 16.

iv) The PENDULUM 16 is coupled to the SHAFT 18 by the BEARINGS 20.

v) The OPTICAL ENCODER 28 and PENDULUM 16 are free to rotate about the SHAFT 18.

vi) Gravity causes the PENDULUM 16 to hang perpendicular to the ground. The orientation of the OPTICAL ENCODER 28 and PENDULUM 16 assembly is thus fixed with respect to the ground.

Operation: Sensing of Angular Displacement.

i) The OPTICAL EMITTERS 24 and OPTICAL DETECTORS 26 are mounted to the base 12. The orientations and positions of the OPTICAL EMITTERS 24, OPTICAL DETECTORS 26, and the base 12 are fixed with respect to each other and do not change.

ii) Angular movement of the crane boom 14 introduces an angular displacement of the OPTICAL EMITTERS 24 and OPTICAL DETECTORS 26 with respect to the fixed orientation of the OPTICAL ENCODER 28 and PENDULUM 16 assembly.

iii) The OPTICAL ENCODER 28 has a series of optical apertures 32 that form specific patterns at different angular positions on the OPTICAL ENCODER 28. For any specific angular position on the OPTICAL ENCODER 28 there is a corresponding specific pattern of optical apertures 32.

iv) The OPTICAL EMITTERS 24 illuminate the OPTICAL ENCODER 28 at an angular position that depends on the angular displacement between the OPTICAL EMITTERS 24 and the OPTICAL ENCODER 28.

v) The specific pattern of optical apertures 32 at any specific angular position on the OPTICAL ENCODER 28 causes a specific illumination of the OPTICAL DETECTORS 26. This specific illumination causes the OPTICAL DETECTORS 26 to generate specific electric currents.

vi) The value of these specific electric currents is a function of the angular displacement between the optical emitters 24 and optical detectors 26 and the OPTICAL ENCODER 28. Thus, an ABSOLUTE ANGULAR POSITION to ELECTRICAL CURRENT conversion has been performed.

vii) The electric currents from the OPTICAL DETECTORS 26 are passed through the OPTICAL DETECTOR CHANNEL SELECTOR 44 to the ANALOG SIGNAL AMPLIFIER 40.

viii) The ANALOG SIGNAL AMPLIFIER 40 transforms the electric currents into electric voltages and amplifies these voltages to levels suitable for input to the ANALOG TO DIGITAL CONVERTER 42.

ix) The ANALOG TO DIGITAL CONVERTER 42 transforms the amplified electric voltages into the binary equivalents of their numeric values. Thus, the ABSOLUTE ANGULAR POSITION is represented by a group of specific binary numbers.

x) There are eight OPTICAL CHANNELS 38. Seven of these OPTICAL CHANNELS 38 are used to sense the pattern of optical apertures 32 on the OPTICAL ENCODER 28. Thus, there are seven binary numbers that represent the illuminance of the OPTICAL DETECTORS 26. One number for each optical channel 38. Each of the seven numbers has a value that ranges from a minimum of zero to a maximum of 255. The value of the number is proportional to the illuminance of the corresponding OPTICAL DETECTOR 26.

xi) The eighth OPTICAL CHANNEL 38 is used for calibration.

xii) The binary numbers from the seven OPTICAL CHANNELS 38 are presented to the FIRST MICROPROCESSOR 36. The FIRST MICROPROCESSOR 36 executes a software algorithm that uses the binary numbers to determine the ABSOLUTE ANGULAR POSITION of THE ANGULAR POSITION INDICATOR 10.

xiii) The output of the software algorithm is a single number that is equal to the angular displacement between the base 12 and the OPTICAL ENCODER 28. This number is temporarily stored in processor memory.

Operation: Data Transmission.

i) The FIRST MICROPROCESSOR 36 reads an IDENTIFICATION NUMBER from the ID ENCODER 46 and stores this number in processor memory.

ii) The FIRST MICROPROCESSOR 36 determines the condition of the battery 30 by instructing the ANALOG CHANNEL MULTIPLEXER 48 to route the battery output voltage to the ANALOG To DIGITAL CONVERTER 42. The ANALOG TO DIGITAL CONVERTER 42 digitizes the battery voltage and presents the data to the FIRST MICROPROCESSOR 36. This data is used to determine the condition of the battery 30.

iii) The FIRST MICROPROCESSOR 36 forms a data packet that consists of the following information:

a) ID Code.

b) Battery Condition

c) Angular Position.

iv) The FIRST MICROPROCESSOR 36 sends the data packet to the RADIO TRANSMITTER 50.

v) The RADIO TRANSMITTER 50 sends the data to the DISPLAY UNIT 54.

Operation: Detailed Example of Angle Measurement.

The pattern of optical apertures 32 at a specific location on the OPTICAL ENCODER 28 is sensed by recording the illumination of the OPTICAL DETECTORS 26 at that location. The illuminance depends on the amount of light that passes through an optical aperture 32 to an OPTICAL DETECTOR 26. If the optical aperture 32 is completely closed then the optical channel 38 is blocked and the illuminance is zero. If the optical aperture 32 is completely open then the optical channel 38 is clear and the illuminance is maximized.

The present design uses seven optical channels 38 to sense the pattern of optical apertures 32. The illuminance through each optical channel 38 is resolved to 1 part in 256, (8 bit resolution, 0.4%).

The FIRST MICROPROCESSOR 36 records the illuminance by gathering data from the OPTICAL DETECTORS 26. A software algorithm determines the ABSOLUTE ANGULAR POSITION of the ANGULAR POSITION INDICATOR 10 using the illuminance data.

In order to prevent undesired cross modulation between optical channels 38, the FIRST MICROPROCESSOR 36 enables and records data from only one optical channel 38 at a time.

Operation: Detailed Example of Angle Measurement.

The illuminance data is collected as follows:

i) The FIRST MICROPROCESSOR 36 instructs the ANALOG CHANNEL MULTIPLEXER 48 to pass output from the ANALOG SIGNAL AMPLIFIER 40 to the ANALOG TO DIGITAL CONVERTER 42.

ii) The FIRST MICROPROCESSOR 36 instructs the emitter channel selector 43 to enable a current path through the first OPTICAL EMITTER 24.

iii) The FIRST MICROPROCESSOR 36 instructs the DIGITAL TO ANALOG CONVERTER 41 to pass current through the first OPTICAL EMITTER 24.

iv) The first OPTICAL EMITTER 24 converts the current passed through it to light. The light illuminates the optical aperture 32 immediately in front of the OPTICAL EMITTER 24.

v) The FIRST MICROPROCESSOR 36 instructs the DETECTOR CHANNEL SELECTOR 44 to enable a current path from the first OPTICAL DETECTOR 26 to the ANALOG SIGNAL AMPLIFIER 40.

vi) The ANALOG SIGNAL AMPLIFIER 40 converts the current from the first OPTICAL DETECTOR 26 to a voltage and amplifies the voltage to a level suitable for input to the ANALOG TO DIGITAL CONVERTER 42. This voltage is routed to the ANALOG TO DIGITAL CONVERTER 42 through the ANALOG CHANNEL MULTIPLEXER 48.

vii) The ANALOG TO DIGITAL CONVERTER 42 digitizes the voltage at its input. The output of the ANALOG TO DIGITAL CONVERTER 42 is a binary number that ranges from a value of 0 to 255 depending on the magnitude of the voltage at its input. The magnitude of the voltage depends on the illumination of the OPTICAL DETECTOR 26, thus the binary output of the ANALOG TO DIGITAL CONVERTER 42 is a number that corresponds to the amount of light that reached the OPTICAL DETECTOR 26 through the first channel of the optical aperture 32. The position of the first channel of the optical aperture 32 with respect to the OPTICAL DETECTOR 26 is represented by the value of the number.

viii) The FIRST MICROPROCESSOR 36 records the binary output of the ANALOG TO DIGITAL CONVERTER 42 in processor memory.

ix) The FIRST MICROPROCESSOR 36 repeats steps to for each of the six remaining optical channels 38. The illumination data recorded by the FIRST MICROPROCESSOR 36 contains information regarding the specific pattern and location of the optical apertures 32 on the OPTICAL ENCODER 28.

x) The FIRST MICROPROCESSOR 36 executes a software algorithm that uses the illumination data to determine the angular position of the ANGULAR POSITION INDICATOR 10. The algorithm proceeds as follows:

a) Each of the seven illumination numbers is compared with a threshold number. A number equal to, or greater than, the threshold corresponds to an optical path where the position of the optical aperture 32 is such that more than 66% of the light emitted by the OPTICAL EMITTER 24 has illuminated the OPTICAL DETECTOR 26. A number less than the threshold corresponds to an optical path where the position of the optical aperture 32 is such that less than 66% of the light has illuminated the OPTICAL DETECTOR 26.

b) The results of the seven comparisons are used to form a 7 bit binary number. The value of this number is equal to the integer value of the angular displacement. The range is from 0 degrees to 127 degrees with a resolution of 1 degree. The pattern of optical apertures 32 on the OPTICAL ENCODER 28 is duplicated every 128 degrees so that a total of 256 degrees can be decoded.

c) Each of the seven illumination numbers is compared with two more threshold numbers. Illumination numbers that are between the threshold numbers correspond to optical paths where the position of the optical aperture 32 is such that 33% to 66% of the light has illuminated the OPTICAL DETECTOR 26. The FIRST MICROPROCESSOR 36 makes a record of the optical paths that have illumination numbers between the two threshold numbers.

d) For each integer value of the angular displacement obtained in (b) there is a corresponding set of numbers obtained in (c). The algorithm uses the information obtained in (c) to determine if the angular displacement obtained in (b) lies between two integer values. Thus, the algorithm is able to resolve the angular displacement to a resolution of ½ degree.

xi) The FIRST MICROPROCESSOR 36 stores the angular displacement in memory.

Operation: Damping of the PENDULUM 16.

i) The OPTICAL ENCODER 28 and PENDULUM 16 are free to rotate about the SHAFT 18. Vibration, shock, angular acceleration, or other such mechanical movements can cause the OPTICAL ENCODER 28 and PENDULUM 16 to swing in an oscillatory manner. Such oscillatory motion will cause errors to be introduced into the angular position measurement since the position of the PENDULUM 16 is assumed to be parallel to the local gravitational field and perpendicular to the ground. Oscillatory motion of the PENDULUM 16 is recorded by the FIRST MICROPROCESSOR 36 since the rate at which the software algorithm determines the angular displacement is much quicker than the natural period of oscillation.

ii) The FIRST MICROPROCESSOR 36 retains a record of angular displacement measurements and executes a software algorithm that calculates the mean angular displacement. The resolution of the calculation is ½ degree.

Operation: System Resolution.

i) The present design uses a software algorithm that resolves the angular displacement to ½ degree. The resolution can be increased by increasing the number of window comparisons made in and making the appropriate calculation.

ii) The ultimate system resolution is determined by the resolution of the ANALOG TO DIGITAL CONVERTER 42 and the size of the optical apertures 32 on the OPTICAL ENCODER 28. The present design has an ultimate system resolution of 1/256 of a degree. (14 arc seconds)

iii) Note that a conventional optical encoder using seven optical channels has a resolution of only 1 part in 128. This resolution corresponds to 2.8 degrees. (approximately 10,000 arc seconds)

Operation: Automated Correction for Variations in Optical Coupling.

i) The OPTICAL ENCODER 28 has an optical channel 38 that is dedicated to monitoring the degree of coupling from the OPTICAL EMITTERS 24 to the OPTICAL DETECTORS 26. Illumination numbers from this optical channel 38 are used to calibrate the other optical channels 38 so that the response of all optical channels 38 is the same The calibration is done by controlling the current that the DIGITAL TO ANALOG CONVERTER 41 passes through the OPTICAL EMITTERS 24.

ii) Variations in optical coupling can occur due to several factors. Output power of optical emitters tends to vary with time, temperature, and individual component tolerances. Induced photo current in optical receptors varies with temperature and individual component tolerances. Optical and mechanical alignment vary during production, as does the mechanical tolerances of encoder discs. A software algorithm is executed periodically to determine if the optical coupling has changed. The algorithm adjusts the OPTICAL EMITTER 24 current as necessary in order to maintain equal response from all optical channels 38.

Operation: Individual Optical Channel Signatures:

i) The OPTICAL ENCODER 28 has a calibration aperture 34 that allows full illumination of all OPTICAL DETECTORS 26 simultaneously. Illumination numbers are taken from the calibration aperture 34 during production. These numbers represent the individual responses of each optical channel 38. The numbers correspond to the efficiency of the optical emitters 24 and optical detectors 26 and are used for calibration.

7) Display Unit 54. Detailed Description and Operation.

A) The Display Unit 54 consists of the following component groups:

i) Radio Receiver 60.

ii) Second Microprocessor 56.

iii) Display Driver 66.

iv) LCD Display 58.

v) Backlight for LCD 59.

vi) ID Encoder 64.

vii) Non-Volatile-Memory 74.

viii) Audible Alarm 68.

ix) Control Voltage Alarm 70

X) Input keys 72

xi) Power Supply Regulators 78.

Operation: Data Flow.

i) The RADIO RECEIVER 60 receives data from the ANGULAR POSITION INDICATOR 10. This data is presented to the SECOND MICROPROCESSOR 56 where it is temporarily stored in internal processor memory.

ii) The SECOND MICROPROCESSOR 56 searches the data for a specific IDENTIFICATION CODE. If the ID CODE in the data matches the ID code that is set by the ID ENCODER 64 then the SECOND MICROPROCESSOR 56 accepts the data as valid. If the ID CODE does not match then the data is rejected. This scheme enables the SECOND MICROPROCESSOR 56 to discriminate between valid data and noise, interference, or either such irrelevant data that may came from the RADIO RECEIVER 60.

iii) The SECOND MICROPROCESSOR 56 sends valid data to the DISPLAY DRIVER 66.

iv) The DISPLAY DRIVER 66 controls the LCD DISPLAY 58. Data from the DISPLAY DRIVER 66 is shown on the LCD DISPLAY 58. This data is the angle that was measured and transmitted by the ANGULAR POSITION INDICATOR 10.

Operation: Left/Right Configuration.

i) The user can select Left or Right mounting configuration of the ANGULAR POSITION INDICATOR 10 using a specific sequence of the INPUT KEYS 72. The selection is stored in the NON-VOLATILE MEMORY 74 so that the system remembers its configuration when the power is removed.

ii) Date received from the ANGULAR POSITION INDICATOR 10 is modified according to the mounting selection. The purpose of the modification is to give the correct sense for which direction of rotation represents positive angular displacement.

Operation: Zero Adjustment.

i) The user can select an offset that is to be added or subtracted from the angle measurement received from the ANGULAR POSITION INDICATOR 10. The offset is entered using the INPUT KEYS 72.

ii) This offset is stored in the NON-VOLATILE MEMORY 74 so that the system remembers its configuration when the power is removed.

Operation: Alarm Indication.

i) The user can select MAXIMUM and MINIMUM limits for comparison with the angle measurement received from the ANGULAR POSITION INDICATOR 10. The limits are entered using the INPUT KEYS 72.

ii) The limits are stored in the NON-VOLATILE MEMORY 74 so that the system remembers its configuration when the power is removed.

iii) If the measured angle is beyond either of these limits then the AUDIBLE ALARM 68 and the CONTROL VOLTAGE ALARM 70 are both activated. The alarm condition results in removal of the control voltage.

Operation: Low Battery Indication.

i) Part of the data sent by the ANGULAR POSITION INDICATOR 10 contains information regarding the condition of its BATTERY 30. The SECOND MICROPROCESSOR 56 examines this data.

ii) If the SECOND MICROPROCESSOR 56 determines that the BATTERY 30 in the ANGULAR POSITION INDICATOR 10 is near the end of its service life then an error code is shown on the LCD DISPLAY 58 and the AUDIBLE ALARM 68 is momentarily activated thus indicating to the user that the battery 30 for the ANGULAR POSITION INDICATOR 10 requires replacement.

Operation: Loss of Radio Communication.

i) If the DISPLAY UNIT 54 does not receive any data from the ANGULAR POSITION INDICATOR 10 for any period of 30 seconds or more then the SECOND MICROPROCESSOR 56 determines that there has been a loss of radio communication with the ANGULAR POSITION INDICATOR 10. The loss of radio communication may be the result of one or more of the following situations:

a) Radio channel corrupted by noise or interference.

b) Component failure in the ANGULAR POSITION INDICATOR 10.

c) Component failure in the DISPLAY UNIT 54.

ii) When a loss of communication condition has been detected by the SECOND MICROPROCESSOR 56 an error code is shown on the LCD DISPLAY 58, the AUDIBLE ALARM 68 is momentarily activated, and the control voltage is removed thus indicating to the user that communication with the ANGULAR POSITION INDICATOR has failed.

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

It will be apparent to one skilled in the art that modifications may be made to the illustrated embodiment without departing from the spirit and scope of the invention as hereinafter defined in the Claims.

The embodiments of the invention in which an exclusive property or privilege is claimed are defined as follows:

1. An angular position indicator for a crane boom, comprising:
a base adapted for mounting to a crane boom that is to have its angular position measured;
a pendulum pivotally mounted to the base and hanging freely in a vertical orientation by force of gravity;
an array of sensors for determining the angular positioning of the pendulum;
a first set of processing electronics including a transmitter;
a second set of processing electronics including a human readable display and a receiver;
one of the first set of processing electronics and the second set of processing electronics calculating angular positioning of the crane boom from data received from the array of sensors;
the second set of processing electronics being remote from the first set of processing electronics, the first set of processing electronics for receiving data from the array of sensors and transmitting a signal which is received by the second set of processing electronics, the second set of processing electronics displaying angular positioning of the crane boom on the human readable display.

2. The angular position indicator as defined in claim 1, wherein the signal passing from the first set of processing electronics to the second set of processing electronics has a unique identification code.

3. The angular position indicator as defined in claim 1, wherein the array of sensors includes optical emitters and optical detectors fixed to the base and an optical encoder mounted to the pendulum, such that the optical emitters and optical detectors are angularly displaced in relation to the optical encoder mounted on the pendulum should any movement of the structure occur, the optical encoder having a series of optical apertures that are illuminated by the optical emitters and which, by such illumination generate unique identifiable light patterns detectable by the optical detectors, the illumination of the optical detectors being a function of optical coupling through optical channels formed by the optical emitters, the optical apertures and the optical detectors, the optical coupling depending upon the position of the optical apertures in the optical channels, for any position of the optical encoder some of the optical channels being fully open, some being fully blocked and at least one being partially open, the first set of processing electronics assigning a fractional value to the degree of optical coupling in the at least one partially open channel to enhance resolution of angular measurement.

4. The angular position indicator as defined in claim 1, wherein the mean angular displacement is displayed in order to compensate for oscillatory motion caused by vibration, shock and angular acceleration.

5. An angular position indicator for a crane boom, comprising:
a base adapted for mounting to a crane boom that is to have its angular position measured;
a pendulum pivotally mounted to the base and hanging freely in a vertical orientation by force of gravity;
an array of sensors for determining the angular positioning of the pendulum, the array of sensors including optical emitters and optical detectors fixed to the base and an optical encoder mounted to the pendulum, such that the optical emitters and optical detectors are angularly displaced in relation to the optical encoder mounted on the pendulum should any movement of the structure occur, the optical encoder having a series of optical apertures that are illuminated by the optical emitters and which, by such illumination generate unique identifiable light patterns detectable by the optical detectors, the illumination of the optical detectors being a function of optical coupling through optical channels formed by the optical emitters, the optical apertures and the optical detectors, the optical coupling depending upon the position of the optical apertures in the optical channels, for any position of the optical encoder some of the optical channels being fully open, some being fully blocked and at least one being partially open;
a first set of processing electronics including a transmitter, the first set of processing electronics receiving data from the array of sensors regarding the optical apertures that are fully illuminated, the optical apertures that are not illuminated, and assigning a fractional value to the degree of illumination of the at least one optical aperture that is partially illuminated to enhance resolution of angular measurement, and calculating mean angular displacement in order to compensate for oscillatory motion caused by vibration, shock and angular acceleration;
a second set of processing electronics including a human readable display, the second set of processing electronics remote from the first set of processing electronics, the first set of processing electronics transmitting a signal with a unique identification code which is received by the second set of processing electronics, the second set of processing electronics displaying angular positioning of the crane boom on the human readable display.

6. An angular position indicator for a crane boom, comprising:
a base adapted for mounting to a crane boom that is to have its angular position measured;
a pendulum pivotally mounted to the base and hanging freely in a vertical orientation by force of gravity;
an array of sensors for determining the angular positioning of the pendulum, including optical emitters and optical detectors fixed to the base and an optical encoder mounted to the pendulum, such that the optical emitters and optical detectors are angularly displaced in relation to the optical encoder mounted on the pendulum should any movement of the structure occur, the optical encoder having a series of optical apertures that are illuminated by the optical emitters and which, by such illumination generate unique identifiable light patterns detectable by the optical detectors, the illumination of the optical detectors being a function of optical coupling through optical channels formed by the optical emitters, the optical apertures and the optical detectors, the optical coupling depending upon the position of the optical apertures in the optical channels, for any position of the optical encoder some of the optical channels being fully open, some being fully blocked and at least one being partially open; and
processing electronics receiving data from the array of sensors regarding the optical apertures that are fully illuminated, the optical apertures that are not illuminated, and assigning a fractional value to the degree of illumination of the at least one optical aperture that is partially illuminated to enhance resolution of angular measurement.
